(19) United States
(12) Patent Application Publication
(10) Pub. No.: US 2010/0276962 A1
(43) Pub. Date: Nov. 4, 2010

(54) ACTIVE FACE SHADE DETECTION IN AUTO SUN-SHADE SYSTEM

(75) Inventors: WENDE ZHANG, Shelby Township, MI (US); Sanjeev M. Naik, Troy, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/432,573

(22) Filed: Apr. 29, 2009

(51) Int. Cl. B60J 3/02

(52) U.S. Cl. 296/97.2

(57) ABSTRACT

A method for identifying a sun-shade line on a vehicle driver's face so as to automatically position a sun blocker at the appropriate location to block the sun. The method includes generating subsequent images of the vehicle driver using a low cost camera and providing a difference image from the subsequent camera images to eliminate stationary parts of the image. The method then filters the difference image to enhance the expected motion from the controlled sun blocker and to remove the un-expected motion, which generates a filter response image that includes an identification of the movement of the sun-shade line from image to image. The method then applies a threshold to the filter response image to remove portions of the filter response image that do not exceed a predetermined intensity, and performs a Hough transform on the thresholded filter response image to identify the sun-shade line on the object.

### BACKGROUND OF THE INVENTION

1. Field of the Invention

This invention relates generally to a system and method for detecting a sun-shade line on a object and, more particularly, to an active system and method for detecting a sun-shade line on a vehicle driver using a low cost camera so as to control the position of a sun blocker in response thereto.

2. Discussion of the Related Art

Most vehicles are equipped with a sun visor that can be selectively flipped down from a stored position if the vehicle is traveling into a low sun angle so that the driver is not staring directly into the sun. The sun visor is typically able to block the sun shining through the windshield, as well as through the windows. The sun visor makes the driving experience more pleasant, and also has an obvious safety value.

Systems have been developed in the art to automatically adjust the position of a sun blocker in response to a sun incident angle. For example, U.S. Pat. No. 6,811,201, titled, Automatic Sun Visor and Solar Shade System for Vehicles, issued Nov. 2, 2004 to Naik, discloses an automatic sun visor system for a vehicle that includes a light detecting apparatus for detecting sunlight incident on the face of an occupant of the vehicle. The system includes a microcontroller that adjusts the sun visor in response to the detected sunlight on the face of the vehicle driver.

Typically, the known GPS-based systems that attempt to automatically control the position of the sun blocker do not take into consideration the location of the vehicle drivers head, and thus drivers of different heights or who make different motions will typically not receive the full benefit of the position of the sun visor that was intended. These known systems were typically passive in nature in that they did not employ feedback to know whether the sun blocker was properly blocking the sun. Thus, it would desirable to provide an active sun visor system that detected a sun-shade line on the vehicle driver and position a sun blocker in response thereto where the system monitored the position of the sun-shade line as the driver and sun blocker move.

### SUMMARY OF THE INVENTION

In accordance with the teachings of the present invention, a system and method are disclosed for identifying a sun-shade line on a vehicle driver's face so as to automatically position a sun blocker at the appropriate location to block the sun. The method includes generating subsequent images of the vehicle driver using a low cost camera and providing a difference image from the subsequent camera images to eliminate stationary parts of the image. The method then filters the difference image to enhance the expected motion from the controlled sun blocker and to remove the un-expected motion, such as from the vehicle driver in the horizontal direction, which generates a filter response image that includes an identification of the movement of the sun-shade line from image to image. The method then applies a threshold to the filter response image to remove portions of the filter response image that do not exceed a predetermined intensity, and performs a Hough transform on the thresholded filter response image to identify the sun-shade line on the object. The Hough transformed image is then sent to a false alarm mitigation and tracking process that removes line segments in the image that are too short to be the sun-shade line.

Additional features of the present invention will become apparent from the following description and appended claims, taken in conjunction with the accompanying drawings.

### BRIEF DESCRIPTION OF THE DRAWINGS

FIG. 1 is an illustration of a system for automatically positioning a sun blocker in a vehicle;

FIG. 2 is a flow chart diagram showing a process for identifying a sun-shade line on the vehicle driver for the system shown in FIG. 1;

FIG. 3 is a graph showing parameters for a Hough transform in the image domain; and

FIG. 4 is a graph showing the parameters in FIG. 3 in the Hough domain.

### DETAILED DESCRIPTION OF THE EMBODIMENTS

The following discussion of the embodiments of the invention directed to a system and method for identifying a sun-shade line on a vehicle driver and automatically positioning a sun blocker in response thereto is merely exemplary in nature, and is in no way intended to limit the invention or its applications or uses. For example, the present invention has specific application for moving a sun blocker in a vehicle. However, as will be appreciated by those skilled in the art, the invention may have application in other environments for detecting a sun-shade line.

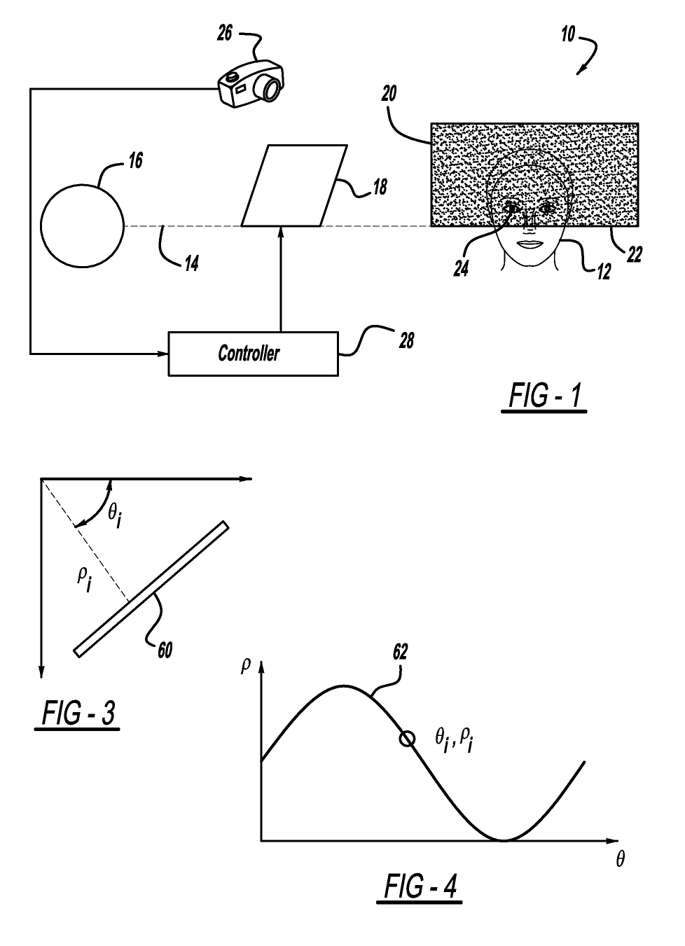

FIG. 1 is an illustration of a system 10 for detecting a sun-shade line on an object 12, such as a vehicle driver. The term sun-shade line as used herein is intended to mean any shade line formed by a light source. A light ray 14 from a light source 16, such as the sun, is directed towards the vehicle driver 12, such as through the vehicle windshield or side window. A sun blocker 18 is positioned between the light source 16 and the driver 12 within the vehicle and causes a shadow 20 to be formed. The shadow 20 causes a sun-shade line 22 to be formed on the face of the object 12, where it is desirable to maintain the blocker 18 in a position where eyes 24 of the driver 12 are within the shadow 20. As will be discussed in detail below, a camera 26 takes images of the driver 12 and sends those images to a controller 28. The camera 26 can be any camera suitable for the purposes described herein, including low cost cameras. The controller 28 filters out noise as a result of motion of the driver 12 from frame-to-frame in the images generated so as to identify the sun-shade line 22 to make sure it is at the proper location as the driver 12 and the blocker 18 moves. As the driver 12 moves and the light source 16 moves, the controller 28 automatically positions the blocker 18 to provide the shadow 20 at the proper location.

The present invention is concerned with identifying the sun-shade line 22 in the images generated by the camera 26. The blocker 18 that forms the shadow 20 can be any blocker that is suitable for the purposes described herein. In one specific embodiment, the blocker 18 is part of the vehicle windshield or side windows, referred to in the industry as “smart glass.” For example, the smart glass can include electro-chromic portions in the windshield or side window that are responsive to electric signals that cause the electro-chromic portions to become opaque.

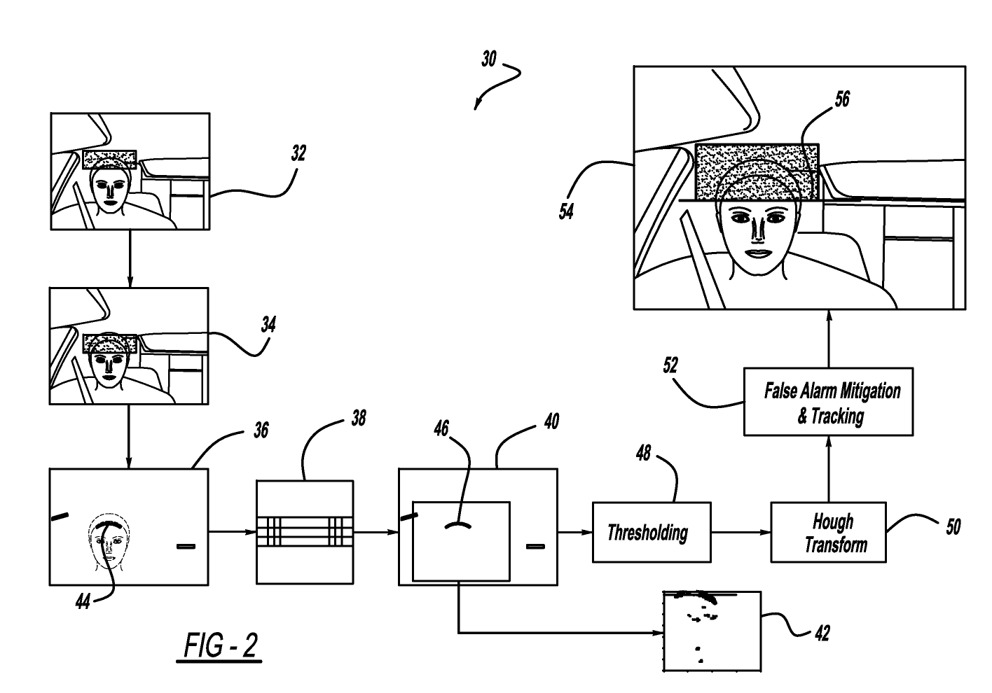

FIG. 2 is a flow-chart diagram 30 showing a process and algorithm used in the controller 28 for identifying the sun-shade line 22. Subsequent image frames 32 and 34 at times k and k−1 are provided by the camera 26 as images of the vehicle driver 12. The algorithm subtracts the subsequent image frames to provide a difference image 36 that defines areas of motion from frame to frame, where the subtraction provided by the difference image 36 removes those parts of the subsequent images that are stationary. The difference image 36 is then filtered by an expected motion filter 38, such as a line detection filter, to enhance the expected motion from the controlled sun blocker 18 and remove the un-expected motion, such as motion from the vehicle driver 12 in the horizontal direction, to generate a filtered response image 40. More specifically, the filter 38 filters the difference image 36 to remove those parts of the subsequent images that are in the difference image 36 as a result of the driver 12 moving in the horizontal direction, which could not be the sun-shade line 22. As the sun-shade line 22 moves in a vertical direction on the face of the driver 12 from image frame to image frame, the difference image 36 from one point in time to the next point in time will show a horizontal band 44 that identifies the location where the sub-shade line 22 is and used to be from one image to the next. The band 44 is not filtered by the filter 38 because it is a result of vertical motion and shows up as a strip 46 in the filtered response image 40.

If the sun-shade line 22 is moving downward from one frame to the next, then the band 44 will create a negative difference in the filter response image 40 and if the sun-shade line 22 is moving upward from one frame to the next, then that band 44 will create a positive difference in the filtered response image 40. If the sun-shade line 22 moves downward from one image frame to the next, then the filter response image 40 is multiplied by a negative one to change the negative band 44 to a positive band 44 that is of a light shade in the filter response image 40 that can be detected. The light regions in the difference image 36 and the filter response image 40 are shown dark in FIG. 2 only for the sake of clarity. A graphical representation 42 of the filter response image 40 can be produced from the filter response image 40 that identifies the lighter regions in the filter response image 40 in a pixel format.

Generally, other vertical motions in the images from one frame to the next frame will include other lighter portions that are not the sun-shade line 22. Known technology in the art allows cameras to detect the face region of the vehicle driver 12. The cropped face region of the filter response image 40 is thus sent to a thresholding box 48 that removes the portions of the filter response image 40 that do not exceed a predetermined intensity threshold to remove at least some of those non-sun-shade line portions. As a result of the thresholding, the thresholded filter response image should mostly only include the strip 46 in the filtered response image 40 identifying the movement of the sun-shade line 22.

The thresholded filter response image is then sent to a Hough transform 50, discussed in more detail below, that identifies areas in the filter response image that form a line. Once lines are identified in the thresholded filter response image, the image it is sent to a false alarm mitigation and pixel tracking box 52 that identifies false sun-shade lines, such as short lines, in the filter response image 40 that cannot be the sun-shade line 22. If the filter response gets through the false alarm mitigation and tracking, then the remaining line identified by the Hough transform 50 is the sun-shade line as shown by line 56 in a resulting image 54. The false alarm mitigation and tracking eliminates short line segments, maintains the temporal smoothing of the detected line's position orientation between neighboring frames using tracking techniques, such as Kalman filtering, particle filtering, etc., and tracks the specific motion pattern from the sun blockers motion.

The Hough transform 50 is a technique for identifying lines in the filter response image 40. The algorithm parameterizes the lines in the image domain with two parameters, where parameter ρ represents the distance between a line and an origin and θ is the angle of the line, as shown in FIG. 3, where reference numeral 60 identifies the line. From this analysis, ρᵢ=x cos θᵢ*+y sin θᵢ. This relationship of the parameters is transferred to the Hough domain, as shown by the graph in FIG. 4, where θ is the horizontal axis and ρ is the vertical axis. Using the same analysis, a fixed point (x,y) corresponds to a sine curve 62 in the Hough domain. The Hough transform finds the peaks in the Hough domain by applying a threshold where the value of the peaks represents the number of points on the line.

Known technology in the art allows cameras to detect the eyes 24 of the vehicle driver 12 and by combining driver eye detection with the algorithm for detecting the sun-shade line 22 discussed above it can be determined whether that line is below the driver's eyes. If the sun-shade line 22 is not below the driver's eyes 24, then the controller 28 can adjust the blocker 18 to the appropriate location.

Although the discussion above concerns detecting the sun-shade line 22 to move the sun blocker 18, the same idea can be applied to other applications. These applications could include active detection that combines traditional passive sensor detection with active device control to detect the expected motion changes due to the controlled motion and drop the un-expected motion that is not related to the controlled motion as an additional cue to improve the object detection accuracy. One specific application would be to detect the position and angle of a robot arm using sensing techniques, such as camera vision, by matching the expected/controlled motion through sensors to provide suitable robot control.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining a sun-shade line on an object, said method comprising:
providing subsequent images of the object;
providing a difference image from a subtraction of the subsequent images to remove stationary portions from one image to the next image;
filtering the difference image to remove motion of the object in a horizontal direction to generate a filter response image that includes portions of the subsequent images that move in a vertical direction from the one image to the next image;
thresholding the filter response image to remove the vertical moving portions in the filter response image that do not exceed a predetermined intensity threshold; and
performing a Hough transform on the threshold filter response image to identify a position of the sun-shade line on the object.

2. The method according to claim 1 wherein providing subsequent images of the object includes providing subsequent images of a vehicle driver.

3. The method according to claim 2 further comprising positioning a sun blocker in response to the identified position of the sun-shade line so that eyes of the vehicle driver are within a shadow caused by the sun blocker.

4. The method according to claim 3 wherein the sun blocker is an electro-chromic vehicle windshield.

5. The method according to claim 1 wherein filtering the difference image includes using a line detection filter.

6. The method according to claim 1 further comprising providing false alarm mitigation and tracking of the Hough transformed image to remove line segments in the image that are too short to be the sun-shade line.

7. The method according to claim 6 wherein performing false alarm mitigation and tracking includes using a Kalman filter.

8. The method according to claim 6 wherein performing false alarm mitigation and tracking includes using a particle filter.

9. The method according to claim 1 further comprising multiplying the filter response image by a negative one if movement of the sun-shade line is downward from the one image to the next image that causes a negative identification of the movement of a sun-shade line.

10. The method according to claim 1 wherein providing subsequent images of the object includes providing subsequent images of the object by a single camera.

11. A method for determining a sun-shade line on a vehicle driver, said method comprising:
providing subsequent images of the vehicle driver using a single camera;
providing a difference image from a subtraction of the subsequent images to remove stationary portions from one image to the next image;
filtering the difference image to remove motion of the object of the vehicle driver in a horizontal direction and enhance expected motion to generate a filter response image that includes portions of the subsequent images that move in a vertical direction from the one image to the next image;
multiplying the filter response image by a negative one if movement of the sun-shade line is downward from the one image to the next image that causes a negative identification of the movement of a sun-shade line;
thresholding the filter response image to remove the vertical moving portions in the filter response image that do not exceed a predetermined intensity threshold;
performing a Hough transform on the thresholded filter response image to identify a position of the sun-shade line on the vehicle driver; and
providing false alarm mitigation and tracking of the Hough transformed image to remove line segments in the image that are too short to be the sun-shade line.

12. The method according to claim 11 further comprising positioning a sun blocker in response to the identified position of the sun-shade line so that eyes of the vehicle driver are within a shadow caused by the sun blocker.

13. The method according to claim 12 wherein the sun blocker is an electro-chromic vehicle windshield.

14. The method according to claim 11 wherein providing false alarm mitigation and tracking includes using a Kalman filter or a particle filter.

15. The method according to claim 11 wherein filtering the difference image includes using a line detection filter.

16. A system for determining a sun-shade line on a vehicle driver, said system comprising:
means for providing subsequent camera images of the vehicle driver;
means for providing a difference image from a subtraction of the subsequent camera images to remove stationary portions from one image to the next image;
means for filtering the difference image to remove motion of the object of the vehicle driver in a horizontal direction to generate a filter response image that includes portions of the subsequent images that move in a vertical direction from the one image to the next image;
means for thresholding the filter response image to remove the vertical moving portions in the filter response image that do not exceed a predetermined intensity threshold;
means for performing a Hough transform on the thresholded filter response image to identify a position of the sun-shade line on the vehicle driver; and
means for providing false alarm mitigation and tracking of the Hough transformed image to remove line segments in the image that are too short to be the sun-shade line.

17. The system according to claim 16 further comprising means for positioning a sun blocker in response to the identified position of the sun-shade line so that eyes of the vehicle driver are within a shadow caused by the sun blocker.

18. The system according to claim 16 wherein the sun blocker is an electro-chromic vehicle windshield.

19. The system according to claim 16 further comprising means for multiplying the filter response image by a negative one if movement of the sun-shade line is downward from the one image to the next image that causes a negative identification of the movement of a sun-shade line.

20. The system according to claim 16 wherein the means for filtering the difference image uses a line detection filter.
